(19) United States
(12) Patent Application Publication
(10) Pub. No.: US 2008/0011160 A1
(43) Pub. Date: Jan. 17, 2008

(54) CARBON DIOXIDE CAPTURE SYSTEMS AND METHODS

(75) Inventors: MICHAEL JOHN BOWMAN, NISKAYUNA, NY (US); STEPHEN DUANE SANBORN, COPAKE, NY (US); ANDREI TRISTAN EVULET, CLIFTON PARK, NY (US); JAMES ANTHONY RUUD, DELMAR, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/457,840

(22) Filed: Jul. 17, 2006

(51) Int. Cl. B01D 53/22

(52) U.S. Cl. 96/4; 95/51

(57) ABSTRACT

A carbon dioxide separation system comprises a heat exchanger having a first flow path for directing a fluid comprising carbon dioxide, for example an exhaust gas, therethrough and a second flow path for directing a heat transfer fluid therethrough, a separator comprising a material with selective permeability of carbon dioxide for separating the first and second flow paths and for promoting thermal transfer and carbon dioxide transport therebetween, and a condenser for condensing the heat transfer fluid to isolate the carbon dioxide. In another embodiment, a carbon dioxide separation system comprises an energy production system for generating electricity and an exhaust gas including carbon dioxide at a temperature greater than about 300C, a heat exchanger having a first flow path for directing the exhaust gas therethrough and a second flow path for directing water therethrough to promote thermal transfer between the first flow path and the second flow path and produce a flow of steam within the second flow path, a carbon dioxide extraction circuit in thermal and mass transfer relationship with the exhaust gas comprising a third flow path for directing a heat transfer fluid therethrough, wherein the carbon dioxide extraction circuit comprises a material with selective permeability of carbon dioxide for promoting thermal transfer and carbon dioxide transport between the exhaust gas and the heat transfer fluid to produce a mixed flow of a gaseous heat transfer fluid and carbon dioxide within the third flow path, and a condenser for receiving the mixed flow and for condensing the mixed flow to isolate the carbon dioxide.

### BACKGROUND

This invention relates generally to carbon capture and more specifically to methods and systems for capturing carbon dioxide.

Before carbon dioxide (CO₂) gas can be sequestered from power plants and other point sources, it must be captured in a relatively pure form. On a mass basis, CO₂ is the nineteenth largest commodity chemical in the United States, and CO₂ is routinely separated and captured as a byproduct of industrial processes such as synthetic ammonia production, hydrogen (H₂) production or limestone calcination.

Existing CO₂ capture technologies, however, are not cost-effective when considered in the context of sequestering CO₂ from power plants. Most power plants and other large point sources use air-fired combustors, a process that exhausts CO₂ diluted with nitrogen. For efficient carbon sequestration, the CO₂ in these exhaust gases must be separated and concentrated.

CO₂ is currently recovered from combustion exhaust by using, for example, amine absorbers and cryogenic coolers. The cost of CO₂ capture using current technology, however, can be as high as $150 per ton—much too high for carbon emissions reduction applications. Furthermore, carbon dioxide capture is generally estimated to represent three-fourths of the total cost of a carbon capture, storage, transport, and sequestration system.

Accordingly, there is a need for a new CO₂ separation system and method to make CO₂ separation and capture from power plants easier and more cost effective.

### BRIEF DESCRIPTION

A carbon dioxide separation system comprises a heat exchanger having a first flow path for directing a fluid comprising carbon dioxide, for example an exhaust gas, therethrough and a second flow path for directing a heat transfer fluid therethrough, a separator comprising a material with selective permeability of carbon dioxide for separating the first and second flow paths and for promoting thermal transfer and carbon dioxide transport therebetween, and a condenser for condensing the heat transfer fluid to isolate the carbon dioxide. In another embodiment, a carbon dioxide separation system comprises an energy production system for generating electricity and an exhaust gas including carbon dioxide at a temperature greater than about 200C, a heat exchanger having a first flow path for directing the exhaust gas therethrough and a second flow path for directing water therethrough to promote thermal transfer between the first flow path and the second flow path and produce a flow of steam within the second flow path, a carbon dioxide extraction circuit in thermal and mass transfer relationship with the exhaust gas comprising a third flow path for directing a heat transfer fluid therethrough, wherein the carbon dioxide extraction circuit comprises a material with selective permeability of carbon dioxide for promoting thermal transfer and carbon dioxide transport between the exhaust gas and the heat transfer fluid to produce a mixed flow of a gaseous heat transfer fluid and carbon dioxide within the third flow path, and a condenser for receiving the mixed flow and for condensing the mixed flow to isolate the carbon dioxide.

### DRAWINGS

These and other features, aspects, and advantages of the present invention will become better understood when the following detailed description is read with reference to the accompanying drawings in which like characters represent like parts throughout the drawings, wherein:

FIG. 1 is a depiction of one embodiment of the instant invention.

FIG. 2 is a partial view of the embodiment of FIG. 1.

FIG. 3 is a depiction of another embodiment of the instant invention.

FIG. 4 is a depiction of yet another embodiment of the instant invention.

### DETAILED DESCRIPTION

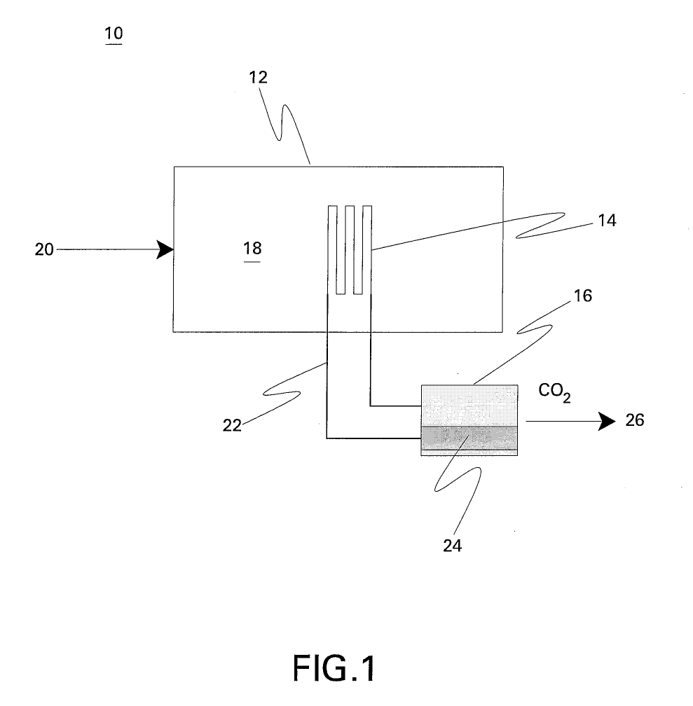

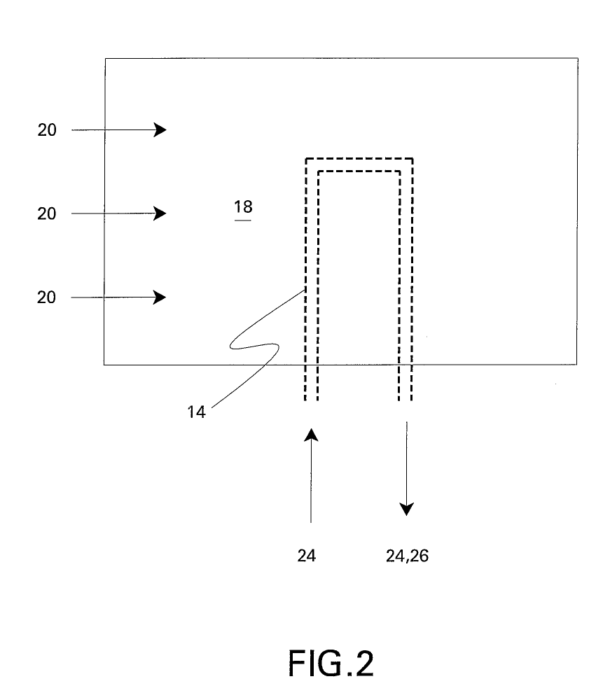

A carbon dioxide separation system 10 comprises a heat exchanger 12, a separator 14 and a condenser 16, as shown in FIG. 1 and FIG. 2. Heat exchanger 12 comprises a first flow path 18 for directing a fluid comprising carbon dioxide 20 therethrough and a second flow path 22, defined at least in part by separator 14, for directing a heat transfer fluid 24 therethrough. In one embodiment, separator 14 comprises a material or structure that enables selective permeability of carbon dioxide. Any suitable material may be used for the separator 14 provided that that material is stable at the operating conditions and has the required permeance and selectivity at those conditions. Materials known to be selective for CO₂ include, for example, certain inorganic and polymer materials. Inorganic materials include microporous carbon, microporous silica, microporous titanosilicate, microporous mixed oxide, and zeolite materials.

While not to be limited by a particular theory, mechanisms for CO₂ selectivity in microporous materials include molecular sieving, surface diffusion and capillary condensation. CO₂ can be removed selectively from a stream containing other gas molecules with a larger kinetic diameter, such as N₂, through a membrane with sufficiently small pores. A material that has an affinity for CO₂ relative to other gases in a stream will show a preferred adsorption and surface diffusion of CO₂. Furthermore, the presence of the adsorbed CO₂ molecules, through capillary condensation, will effectively block the pore from the more weakly adsorbing gases, thereby hindering their transport. The performance properties of such inorganic membranes at a given operating condition can be improved by a person skilled in the art by modifying the surface, altering the pore size or changing the composition of the membrane.

Hybrid membranes that incorporate polymer and ceramic materials integrated at the molecular level can show enhanced CO₂ selectivity properties at elevated operating conditions. The invention is not restricted to any particular membrane material or type and encompasses any membrane comprising any material that is capable of providing suitable levels of permeance and selectivity. That includes, for example, mixed matrix membranes, facilitated transport membranes, ionic liquid membranes, and polymerized ionic liquid membranes. In practice, separator 14 often comprises a separation layer that is disposed upon a support layer. For asymmetric inorganic membranes, the porous support can comprise a material that is different from the separation layer. Support materials for asymmetric inorganic membranes include porous alumina, titania, cordierite, carbon, Vycor and metals. Porous metal support layers include stainless steel, iron-based alloys, nickel, and nickel-based alloys.

Separator 14 physically separates first flow path 18 and second flow path 22 and promotes thermal transfer and carbon dioxide transport therebetween. Condenser 16 is in flow communication with second flow path 22 and receives and condenses the heat transfer fluid 24 to isolate carbon dioxide 26 contained therein.

In one embodiment, fluid comprising carbon dioxide 20 is an exhaust gas, for example, an exhaust gas having a temperature in the range between about 200C to about 700C. The high temperature exhaust gas 20 is directed into heat exchanger 12 along first flow path 18. At least a portion of second flow path 22 is defined by separator 14. For example, in one embodiment second flow path 22 is defined by piping or tubing and a portion of that piping or tubing is exposed to the high temperature exhaust gas 20 (i.e. separator 14) and is made of a material with selective permeability of carbon dioxide. Separator 14 is integrated within the carbon dioxide separation system 10 to be in thermal transfer and carbon dioxide transport relationship with the first flow path 18. As separator 14 is exposed to the high temperature exhaust gas 20, at least a portion of the carbon dioxide contained within the exhaust gas 20 is transported through separator 14 to the heat transfer fluid 24 contained within the second flow path 22. Additionally, the heat transfer fluid 24 extracts heat from the exhaust gas and, in turn, undergoes a phase change to a gaseous phase.

The gaseous phase heat transfer fluid 24 containing carbon dioxide is directed to condenser 16, where the heat transfer fluid 24 is condensed back to a liquid phase and the carbon dioxide 26 is isolated in a gaseous form within the condenser 16. While this invention has been discussed in relation to higher temperature exhaust gas containing carbon dioxide 20, this invention can be utilized with fluids containing carbon dioxide 20 over a wide range of temperatures. This system can be utilized over a wide range of systems for any exhaust gas, for example, furnace exhaust, thermal oxidizers, metal processing or any other industrial process. In fact, fluids containing carbon dioxide 20 can be at ambient temperature with a suitable phase change heat transfer fluid 24 being selected, for example, refrigerant, alcohols like butane, silicon oils or the like. In addition, while this invention is discussed in relation to CO₂ capture systems, a material selective to other constituents within the exhaust gas steam, for example, CO, NOx or other pollutants or species, may be utilized to capture the other constituents in a similar fashion.

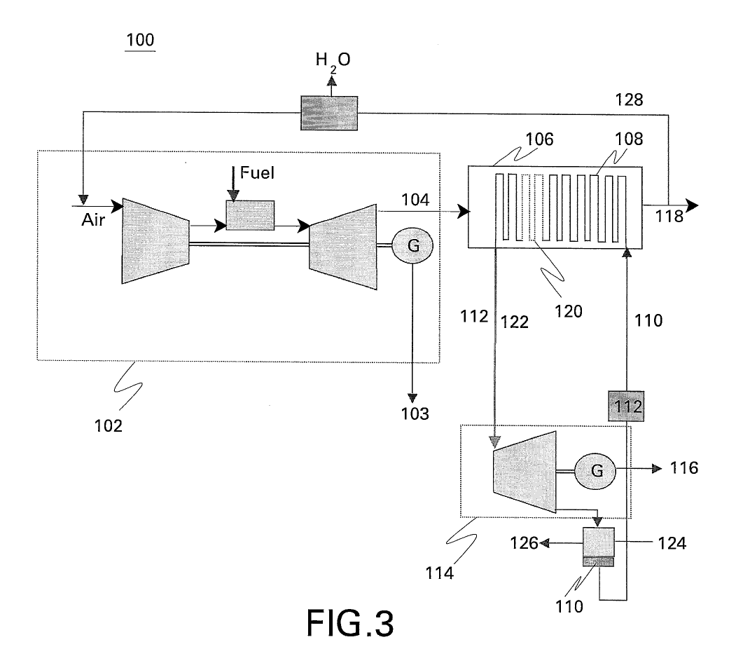

A combined cycle CO₂ capture system 100 of the instant invention is shown in FIG. 3. Combined cycle carbon capture system 100 includes an electricity generation system 102, for example a gas turbine, for producing electricity 103 and a high temperature exhaust gas 104. The exhaust gas 104 typically has a temperature in the range between about 500C to about 700C. The high temperature exhaust gas 104 is directed into a heat recovery steam generator (HRSG) 106. The HRSG 106 contains at least one cooling circuit 108. Water 110 is directed through cooling circuit 108 by a pump 112 and as the water 110 is circulated through the cooling circuit 108 heat is extracted from the high temperature exhaust gas 104 and the water 110 undergoes a phase change to produce a steam exhaust 112 that is directed to a steam turbine system 114 to generate additional electricity 116. The high temperature exhaust gas 104 is cooled to a temperature in the range between about 250C to about 350C prior to exiting the HRSG 106 as a reduced temperature exhaust gas 118.

At least a portion of at least one cooling circuit 108 is a carbon dioxide extraction circuit 120. Carbon dioxide extraction circuit 120 is made of a material with selective permeability of carbon dioxide. As the high temperature exhaust gas 104 travels through the HRSG 106 and contacts the carbon dioxide extraction circuit 120, carbon dioxide 122 is transported through the carbon dioxide extraction circuit 120 into the water 110 or steam 112 that is circulating through the cooling circuit and is directed to the steam turbine system 114 along with the steam 112. The mixed flow of steam 112 and CO₂ 122 is directed to steam turbine system 114 to generate electricity. The content of the CO₂ 122 within the steam turbine system 114 may lead to an improvement in the overall work extracted from the system. The flow exiting steam turbine system 114 is directed to a condenser 124 where the steam 112 is condensed back to water 110, which water 110 is then typically directed back to the HRSG 106. The CO₂ 122, is isolated in the condenser 124 and is drawn off along path 126 to be captured, stored, or otherwise utilized.

In one embodiment, a portion 128 of reduced temperature exhaust gas 118 is recycled back to the electricity generation system 102 to increase the overall CO₂ content in the exhaust gas 104 to improve the extraction efficiency of the system 100. Ideally, the CO₂ content of exhaust gas 104 should be in the range between about 10% by volume to about 15% by volume for improved extraction efficiency through carbon dioxide extraction circuit 120. In order to achieve these levels of CO₂ such technologies as exhaust gas recirculation can be employed.

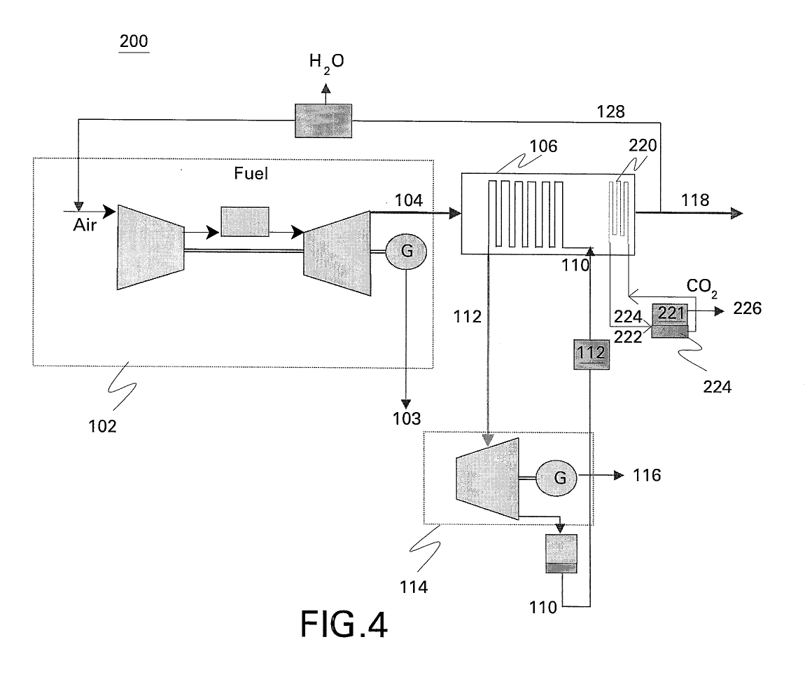

A retrofitable carbon capture system 200 of the instant invention is shown in FIG. 4. Retrofitable carbon capture system 200 includes an electricity generation system 102, for example a gas turbine, for producing electricity 103 and a high temperature exhaust gas 104. The exhaust gas 104 typically has a temperature in the range between about 500C to about 700C. The high temperature exhaust gas 104 is directed into a heat recovery steam generator (HRSG) 106. The HRSG 106 contains at least one cooling circuit 108. Water 110 is directed through cooling circuit 108 by a pump 112 and as the water 110 is circulated through the cooling circuit 108 heat is pulled from the high temperature exhaust gas 104 and the water 110 undergoes a phase change to produce a steam 112 exhaust that is directed to a steam turbine system 114 to generate additional electricity 116. The high temperature exhaust gas 104 is cooled to a temperature in the range between about 250C to about 350C prior to exiting the HRSG 106 as a reduced temperature exhaust gas 118.

Retrofitable carbon capture system 200 further comprises a carbon dioxide extraction system 202. Carbon dioxide extraction system 202 includes an extraction circuit 220 that is made of a material with selective permeability of carbon dioxide and a condenser 221. A heat transfer fluid 224 is directed through the carbon extraction circuit 220 and upon exposure to a predetermined temperature of exhaust gas, undergoes a phase change from a liquid to gaseous phase. As the high temperature exhaust gas 104 travels through the HRSG 106 and contacts the carbon dioxide extraction circuit 220, carbon dioxide 222 is transported through the carbon dioxide extraction circuit 220 into the heat transfer fluid 224 that is circulating through the extraction circuit 220. The mixed flow of heat transfer fluid 224 and CO₂ 222 is directed to condenser 221 where the heat transfer fluid 224 is condensed back to a liquid phase. The CO₂ 222, is isolated in the condenser 221 and is drawn off along path 226 to be captured, stored, or otherwise utilized.

Retrofitable carbon capture system 200 offers the significant benefit that it can be retrofitted into any installed system for immediate utilization and carbon capture. The heat transfer fluid 224 is selected based on the temperatures that the extraction circuit 220 is exposed to.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A carbon dioxide separation system comprising:
a heat exchanger comprising a first flow path for directing a fluid comprising carbon dioxide therethrough and a second flow path for directing a heat transfer fluid therethrough;
a separator comprising a material with selective permeability of carbon dioxide for separating said first and said second flow paths and for promoting thermal transfer and carbon dioxide transport therebetween; and
a condenser for condensing said heat transfer fluid to isolate said carbon dioxide.

2. A carbon dioxide separation system in accordance with claim 1, wherein said fluid is an exhaust gas.

3. A carbon dioxide separation system in accordance with claim 2, wherein said exhaust gas is in the temperature range between about 200C to about 700C.

4. A carbon dioxide separation system in accordance with claim 1, wherein said heat transfer fluid is water.

5. A carbon dioxide separation system in accordance with claim 4, further comprising a steam turbine for receiving said heat transfer fluid in a gaseous phase and for extracting work therefrom.

6. A carbon dioxide separation system in accordance with claim 1, wherein said separator comprises a material selected from the group of, microporous carbon, microporous silica, microporous titanosilicate, microporous mixed oxide and zeolite materials, and hybrid membranes.

7. A carbon dioxide separation system in accordance with claim 1, wherein said separator comprises a separation layer disposed upon a support layer.

8. A carbon dioxide separation system in accordance with claim 7, wherein said support layer comprises porous metal.

9. A carbon dioxide separation system in accordance with claim 8, wherein said porous metal comprises at least one of stainless steel, iron-based-alloy, nickel, nickel-based-alloy and combinations thereof.

10. A carbon dioxide separation system in accordance with claim 2, wherein said exhaust gas is produced from at least one of a gas turbine, a furnace, a thermal oxidizer, metal processing systems, or an industrial process.

11. A carbon dioxide separation system in accordance with claim 1, wherein said heat transfer fluid is selected from the group consisting of water, refrigerant, alcohols or silicon oils or combinations thereof.

12. A carbon dioxide separation system comprising:
an energy production system for generating electricity and an exhaust gas comprising carbon dioxide at a temperature greater than about 200C.
a heat exchanger comprising a first flow path for directing said exhaust gas therethrough and a second flow path for directing water therethrough;
a separator comprising a material with selective permeability of carbon dioxide for separating said first and said second flow paths and for promoting thermal transfer and carbon dioxide transport therebetween to produce a mixed flow of steam and carbon dioxide within said second flow path;
a steam turbine for receiving said mixed flow of steam and carbon dioxide and for extracting work therefrom; and
a condenser for receiving said mixed flow and for condensing said mixed flow to isolate the carbon dioxide.

13. A carbon dioxide separation system in accordance with claim 12, wherein said energy production system is a gas turbine.

14. A carbon dioxide separation system in accordance with claim 12, wherein said exhaust gas comprising carbon dioxide is at a temperature between about 400C and about 700C.

15. A carbon dioxide separation system in accordance with claim 12, wherein said heat exchanger is a Heat Recovery Steam Generator (HRSG).

16. A carbon dioxide separation system in accordance with claim 15, wherein said separator is at least one heat exchange circuit within said HRSG.

17. A carbon dioxide separation system in accordance with claim 12, wherein said separator comprises a material selected from the group of microporous carbon, microporous silica, microporous titanosilicate, microporous mixed oxide and zeolite materials, and hybrid membranes.

18. A carbon dioxide separation system in accordance with claim 12, further comprising a recycle flow path from said heat exchanger to said energy production system to recycle at least a portion of said exhaust gas to said energy production system.

19. A carbon dioxide separation system comprising:
an energy production system for generating electricity and an exhaust gas comprising carbon dioxide at a temperature greater than about 200C;
a heat exchanger comprising a first flow path for directing said exhaust gas therethrough and a second flow path for directing water therethrough to promote thermal transfer between the first flow path and the second flow path and produce a flow of steam within said second flow path;
a carbon dioxide extraction circuit in thermal and mass transfer relationship with said exhaust gas comprising a third flow path for directing a heat transfer fluid therethrough;
wherein said carbon dioxide extraction circuit comprises a material with selective permeability of carbon dioxide for promoting thermal transfer and carbon dioxide transport between said exhaust gas and said heat transfer fluid to produce a mixed flow of a gaseous heat transfer fluid and carbon dioxide within said third flow path; and
a condenser for receiving said mixed flow and for condensing said mixed flow to isolate the carbon dioxide.

20. A species separation system comprising:
a heat exchanger comprising a first flow path for directing a fluid comprising said species therethrough and a second flow path for directing a heat transfer fluid therethrough;
a separator comprising a material with selective permeability of said species for separating said first and said second flow paths and for promoting thermal transfer and species transport therebetween; and
a condenser for condensing said heat transfer fluid to isolate said species.

21. A species separation system in accordance with claim 20, wherein said species is selected from the group consisting of carbon dioxide, carbon monoxide, nitrous oxide, nitrogen dioxide, sulfur dioxide or combinations thereof.
